(19) United States
(12) Patent Application Publication
(10) Pub. No.: US 2002/0002472 A1
(43) Pub. Date: Jan. 3, 2002

(54) Method and apparatus for automated identification of health risks for a patient

(76) Inventor: Klaus Abraham-Fuchs, Erlangen (DE)

Correspondence Address: SCHIFF HARDIN & WAITE, 6600 SEARS TOWER, 233 S WACKER DR, CHICAGO, IL, 60606-6473, US

(21) Appl. No.: 09/837,355

(22) Filed: Apr. 18, 2001

(30) Foreign Application Priority Data
Apr. 19, 2000 (DE) 10019498.2

(51) Int. Cl. G06F 17/60

(52) U.S. Cl. 705/3

(57) ABSTRACT

In a method and an apparatus for the automated discovery of health risks for a patient, an electronic data bank for patient data supplies data to an expert system that can, using implemented medical rules, derive a suspect diagnosis or an increased risk of disease from a combination of data. As a result of every entry of new data into the data bank, the new data are simultaneously played together with all data already stored for this patient for the expert system that is thereby simultaneously started. Given a modified risk evaluation, the expert system outputs a message to the patient or to the attending physician, for example at the data input location.

### BACKGROUND OF THE INVENTION

1. Field of the Invention

The present invention is directed to a method for automated discovery of health risks for a patient wherein an electronic data bank stores patient data (EPR) and an expert system, using implemented medical rules, derives a suspect diagnosis or an increased health risk from the data, as well as to an apparatus for the implementation of such a method.

2. Description of the Prior Art

Current health systems, specifically in the world's highly industrialized countries, are distinguished by a pronounced distribution of roles and a high degree of specialization on the part of the physicians. As a result, medically relevant information is collected as many different data entries (data sets) and at a large variety of times. It therefore frequently occurs that a physician who is attending a patient at the moment does not have the sum of all medical information available that can lead to the diagnosis of an illness or to the recognition of an increased risk condition of a patient that requires treatment. The illness is therefore overlooked, even though the needed information for recognizing the illness would be present somewhere else. An important step in alleviating this deficiency is the establishment of an “electronic patient report” that has become possible as a result of modern information and communication (I&C) technologies. One possible implementation of an EPR is, for example, that of storing all medically relevant data at the location at which they are collected (medical practice, hospital, etc.) and making this information available to other authorized parties at any location and at any time by networking with a central server. As a result, all information for a patient would then be theoretically available to the physician treating the patient at the moment. The amount of information, however, will be far too great for the physician, given a new measured value that is not suspect by itself, to be able to consult the entire information of the data bank in order to recognize a caution indication that only derives as a result of the linking with earlier information.

U.S. Pat. No. 5,517,405 discloses a method and an apparatus for the implementation of the method of the type initially described. A computer-supported decision system is disclosed that makes it possible for a user to decide whether he or she should accept or reject a proposed solution for a problem. After an inquiry to the system, whereby data describing complaints of the patient are entered, the system determines what the actual causes of the complaints are and outputs treatment proposals.

### SUMMARY OF THE INVENTION

An object of the present invention is to provide an automated sifting and evaluation of the quantities of data in addition to storing the data and management of the data flow.

This object is inventively achieved in a method and apparatus wherein as a result of every input of new data into the EPR, the new data are simultaneously played together with all data already stored for this patient for the expert system that is thereby simultaneously started and, given a modified risk evaluation, the expert system outputs a message to the patient or to the attending physician, for example at the input location. Simultaneously with a request for a corresponding action—for example, “go to your doctor in order to have examination X carried out” or “Your life signs indicate a noticeably increased risk of disease Y. You can find information about this disease and possible preventative measures at web page Z.”—the expert system can also suggest additional therapy measures.

According to the present invention, thus, a specific linking of the patient data in the EPR with an expert system ensues such that, given every new data input for a patient, the old data of the patient together with the new data are made available to the expert system, which is simultaneously started in order to automatically reevaluate the recorded patient data. An automatic access of the expert system to the stored data can ensue as a result of the start of the expert system. This thinking determines whether a new illness or an increased risk of a disease can be found as a result of the new input data. If this is not the case, then the expert system automatically shuts down. If, however, there is an altered risk evaluation, then it reports to different recipient locations, i.e. particularly to the patient of the patient's physician.

For the implementation of the inventive method, an electronic data bank for patient data (EPR) having at least one input terminal and an expert system, for example in the form of a Bayes' network or a fuzzy logic algorithm, has a linkage system allocated to it that starts the expert system given actuation of an input terminal and makes all input data and all stored data of the patient available to the expert system.

The expert system connected to prescribable recipients can be integrated in the central server of the EPR, and the linkage system should be fashioned such that it enables the simultaneous acquisition of all stored patient data even given a decentralized structure of the EPR.

### DESCRIPTION OF THE DRAWINGS

FIG. 1 is a flowchart of the sequence of the inventive method for automatic discovery of health risks of a patient.

FIG. 2 is a schematic block diagram of the structure of the apparatus for the implementation of the method.

### DESCRIPTION OF THE PREFERRED EMBODIMENTS

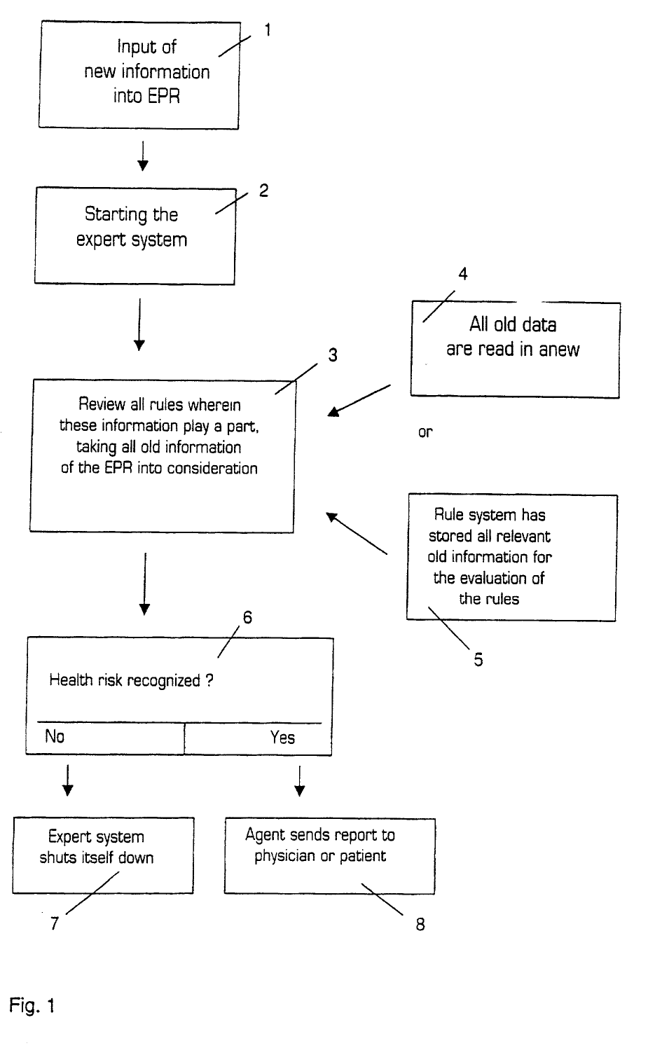

In step 1 of the flowchart shown in FIG. 1, an input of new information ensues into an electronic data bank for patient data. As a result, an expert system linked to the EPR is automatically started. The expert system this implements a review of all rules in which these information play a part, taking all old information in the EPR into consideration. In order to consider the old information together with the new, the new data are either entered into the expert system according to method step 4 together with the staring of the expert system, or the rule system is integrated in the EPR such that the old data are directly available to it (method sequence step 5 according to FIG. 1). In step 6, the expert system compiles a reevaluation with respect to a health risk based on all of the data. Given non-diagnosis of new risks or diseases, the expert system automatically shuts down according to step 7 or, according to step 8, sends a report to the physician or to the patient.

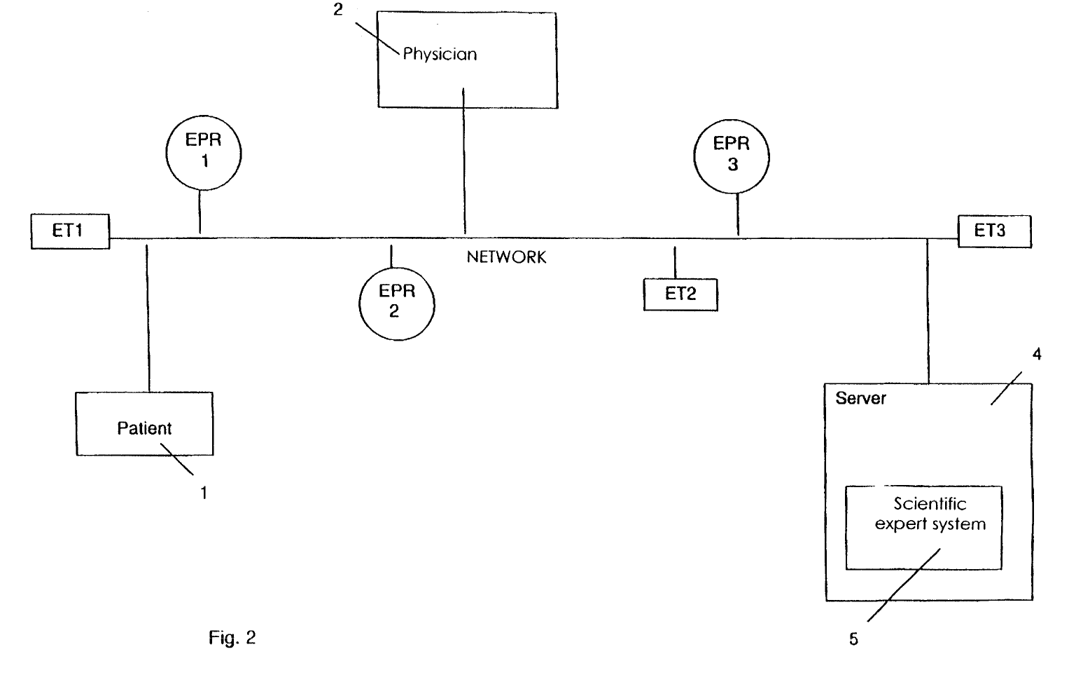

FIG. 2 schematically shows the system for the implementation of the inventive method, wherein the patient 1 and the physician 2 as well as, potentially, a few additional input terminals ET1, ET2 and ET3 are connected via a network 3 to an electronic data bank for patient data, these being indicated as EPR1, EPR2, EPR3 in the schematic illustration of FIG. 2. A server 4 links the input terminals of the patient, the physician and the electronic data bank for patient data to one another via the network 3 as well as with a scientific expert system 5, which is integrated in the server 4 in the exemplary embodiment but, of course, could also be arranged at some other location.

The invention is not limited to the illustrated exemplary embodiment. The nature and fashion of the linking of the input locations with the EPR and the expert system as well as the different possibilities of a feedback could also be realized in some other way. The patient for the present invention is the automatic usage of an expert system given every new patient data input upon simultaneous consultation of the old, stored patient data.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for automated identification of health risks for a patient, comprising the steps of:
obtaining health-related patient data, as accumulated patient data, for a patient and storing said accumulated data in an electronic data bank;
providing an expert system which is operable on said accumulated data, using a stored medical rule system, to identify a health risk for said patient;
obtaining new health-related data for said patient and entering said new data into said electronic data bank for storage together with said accumulated data;
upon every entry of new data into said electronic data bank, simultaneously playing said new data together with said accumulated data in said expert system with said expert system being started upon each entry of new data to operate on said accumulated data together with said new data to produce a modified health risk evaluation; and
making said modified health risk evaluation available from said expert system to at least one of the patient and an attending physician.

2. A method as claimed in claim 1 wherein the step of entering said new data into said electronic data bank comprises entering said new data into said electronic data bank at a data entry location, and wherein the step of making said modified health risk evaluation available comprises making said modified health risk evaluation available at said data entry location.

3. A method as claimed in claim 1 comprising the additional step of producing a therapy proposal for said patient in said expert system in addition to said modified risk evaluation, and making said therapy proposal available to at least one of the patient and an attending physician simultaneously with said modified health risk evaluation.

4. A method as claimed in claim 1 comprising the additional step of producing a examination proposal for said patient in said expert system in addition to said modified risk evaluation, and making said examination proposal available to at least one of the patient and an attending physician simultaneously with said modified health risk evaluation.

5. An apparatus for automated identification of health risks for a patient, comprising:
an electronic data bank containing accumulated health-related patient data for a patient;
an input terminal connected to said electronic bank for entering new patient data for said patient into said electronic data bank;
an expert system having access to said accumulated patient data and said new data in said electronic data bank, said expert system having predetermined medical rules stored therein; and
a linkage connecting said input terminal and said expert system for automatically starting said expert system upon each entry of new data into said electronic data bank via said input terminal, for causing said expert system to operate on said new patient data and said accumulated data, in combination, using said medical rules to produce a risk evaluation for said patient.

6. An apparatus as claimed in claim 5 wherein said electronic data bank has a central server associated therewith, and wherein said expert system is integrated in said central server.

7. An apparatus as claimed in claim 5 wherein said electronic data bank comprises a plurality of decentralized data banks, said decentralized data banks respectively storing portions of at least said accumulated patient data, and wherein said linkage makes the respective portions of said accumulated patient data simultaneously available to said expert system upon each entry of new patient data via said input terminal.
